(19) United States
(12) Patent Application Publication
(10) Pub. No.: US 2005/0160291 A1
(43) Pub. Date: Jul. 21, 2005

(54) System and method for securing network-connected resources

(75) Inventors: Guy Eden, (US); Lena Sojian, (US)

Correspondence Address: Law Office of Gerald Maliszewski, P.O. Box 270829, San Diego, CA, 92198-2829, US

(73) Assignee: Sharp Laboratories of America, Inc.

(21) Appl. No.: 10/759,895

(22) Filed: Jan. 16, 2004

(51) Int. Cl. H04L 9/00

(52) U.S. Cl. 713/201

(57) ABSTRACT

A system and method are provided for securing network-connected resources. The method comprises: receiving an electronically formatted job at a first network-connected node; receiving CK, a symmetrical encryption key (K) encrypted using an asymmetrical encryption public key (pubK); and, receiving CH, a hash (H) of the job, further encrypted using K. Then, the method: decrypts CK using an asymmetrical encryption private key (privK), corresponding to pubK, to recover K; hashes the job, generating H′; uses K to validate CH; in response to validating CH, decrypts an encrypted resource using K; and, uses the decrypted resource to process the job. In one aspect of the method, using K to validate CH includes: encrypting H′ using K, obtaining CH′; and, matching CH to CH′. Alternately, K is used to validate CH by: decrypting CH using K, generating H; and, comparing H to H′.

### BACKGROUND OF THE INVENTION

1. Field of the Invention

This invention generally relates to encrypted communications and, more particularly, to a system and method for securing access to resources embedded in network-connected devices.

2. Description of the Related Art

There are situations in which a network administrator may seek to limit access to network-connected devices, such as printers, copiers, and multifunctional peripheral (MFP) devices. For example, if a printer is equipped with secure resources, such as font dual in-line memory modules (DIMMs), the fonts are vulnerable to theft or unauthorized use. Using basic hardware tools, a person can easily remove the secure font DIMM from the printer, and plug the DIMM on another printer, to gain access to the secure fonts.

One solution to this problem is to provide customers with a removable storage device to store the resource, in this case a secure font DIMM. This device houses the secure font DIMMS, and plugs directly into the printer when the fonts are needed. When the fonts are no longer needed, the device is unplugged from the printer, and stored for safekeeping. Although this solution provides some protection, it increases administrative overhead by making a person responsible for the secure font DIMM. This method also places the DIMMS at risk of being misused or misplaced.

It would be advantageous if device resources could be secured without having to physically remove the resources for safekeeping.

It would be advantageous if device resources could be encrypted in device memory and accessed using a cryptographic mechanism.

### SUMMARY OF THE INVENTION

The present invention method secures device resources, such as fonts, by encrypting the resource before it is saved to DIMM. The encrypted fonts cannot be used until being decrypted using encryption keys. This provides a higher-level of security for storing secure printer fonts, and eliminates the added costs of maintaining extra hardware to secure the fonts.

Accordingly, a method is provided for securing network-connected resources. The method comprises: receiving an electronically formatted job at a first network-connected node; receiving CK, a symmetrical encryption key (K) encrypted using an asymmetrical encryption public key (pubK); and, receiving CH, a hash (H) of the job, further encrypted using K. Then, the method: decrypts CK using an asymmetrical encryption private key (privK), corresponding to pubK, to recover K; hashes the job, generating H′; uses K to validate CH; in response to validating CH, decrypts an encrypted resource using K; and, uses the decrypted resource to process the job.

In one aspect of the method, using K to validate CH includes: encrypting H′ using K, obtaining CH′; and, matching CH to CH′. Alternately, K is used to validate CH by: decrypting CH using K, generating H; and, comparing H to H′.

The received print job can be in either a text or an image format and, as mentioned above, the encrypted resource can be an encrypted font resource. Then, the print job can be printed using the decrypted fonts. The encrypted font resource can be a logo, personal signature image, or a glyph.

Additional details of the above-described method and a system for using secure network-connected resources are provided below.

### BRIEF DESCRIPTION OF THE DRAWINGS

FIG. 1 is a schematic block diagram of the present invention system for using secure network-connected resources.

FIG. 2 is a schematic block diagram illustrating an alternate aspect of the system shown in FIG. 1.

FIG. 3 is a schematic block diagram illustrating a multi-device aspect of the present invention.

FIG. 4 is a schematic block diagram of the present invention system of FIG. 3, where multiple symmetrical encryption keys are used, in addition to multiple asymmetrical key sets.

FIGS. 5a and 5b are flowcharts illustrating the present invention method for securing network-connected resources.

FIG. 6 is a flowchart illustrating the present invention method for accessing network-connected processing resources.

### DETAILED DESCRIPTION OF THE PREFERRED EMBODIMENTS

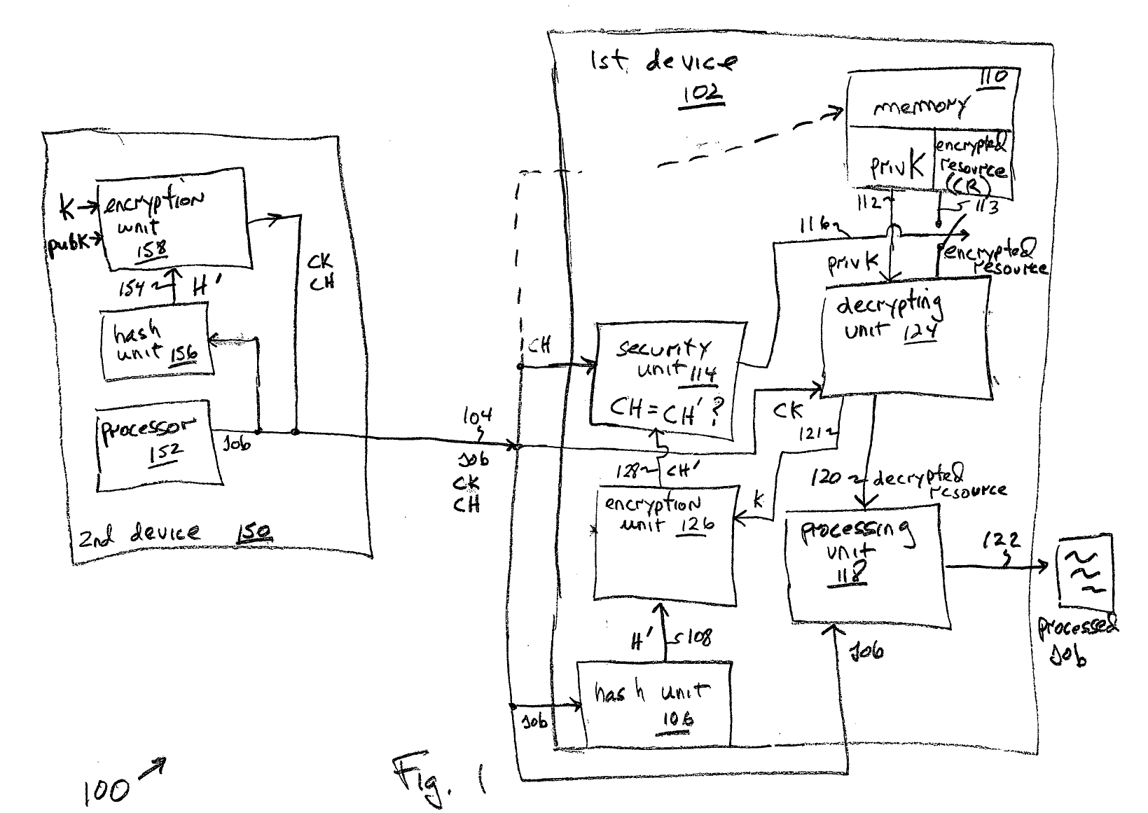

FIG. 1 is a schematic block diagram of the present invention system for using secure network-connected resources. The system 100 comprises a first device 102. The first device 102 includes a network-connected port on line 104 for receiving an electronically formatted job, and for receiving CK. CK is a symmetrical encryption key (K) encrypted using an asymmetrical encryption public key (pubK). Also received is CH, a hash (H) of the job, further encrypted using K.

A public key encryption algorithm (a.k.a.: asymmetric encryption) is an algorithm, which uses one key (a public key) for encrypting the message, and a second key (private key) for decrypting it. If Bob wants to send a ciphertext to Alice, he would use her public key for the task. While everyone can encrypt a message using Alice's public key, Alice is the only one who can decipher the message.

Symmetric encryption, also called conventional encryption, is any encryption system where the same key (K) is use for both encryption and decryption. This requires that the key must be securely transmitted between the encryptor and decryptor.

A one-way hash function typically takes a variable-length message and produces a fixed-length hash. It is computationally impossible to find the message in the hash. In fact, one can't determine any usable information about a message from its hash, not even a single bit. For some one-way hash functions, it's also computationally impossible to determine two messages that produce the same hash.

A hash unit 106 has an interface on line 104 to accept the job and an interface on line 108 to supply a hash of the job (H′). A memory 110 has an interface on line 112 to supply an asymmetrical encryption private key (privK), corresponding to pubK, and an interface on line 113 to supply an encrypted resource (CR). A security unit 114 has an interface on line 116 to authorize access to the encrypted resource in memory 110, in response to validating CH. A processing unit 118 has an interface on line 104 to accept the job and an interface on line 120 to accept a decrypted resource (DR). The processing unit 118 has an interface on line 122 to supply a job processed using the decrypted resource. Although the processed job is shown as a paper media document, in other aspects of the system 100 (not shown) it is an electronically formatted document.

The system 100 further comprises a decrypting unit 124 having an interface on line 104 to accept CK and an interface on line 112 to accept privK. The decrypting unit 124 generates K in response to decrypting CK using privK. The decrypting unit 124 uses K to decrypt the encrypted resource from memory 110. The decrypted resource is supplied at an interface on line 120. An encryption unit 126 has an interface on line 108 to accept H′ and an interface on line 121 to accept K. The encryption unit 126 supplies CH′ at an interface on line 128 in response to using K to encrypt H′. The security unit 114 accepts CH on line 104 and CH′ on line 128 and validates CH by matching CH to CH′. Thus, K must be derived (decrypted) from received information every time a secure resource is to be accessed.

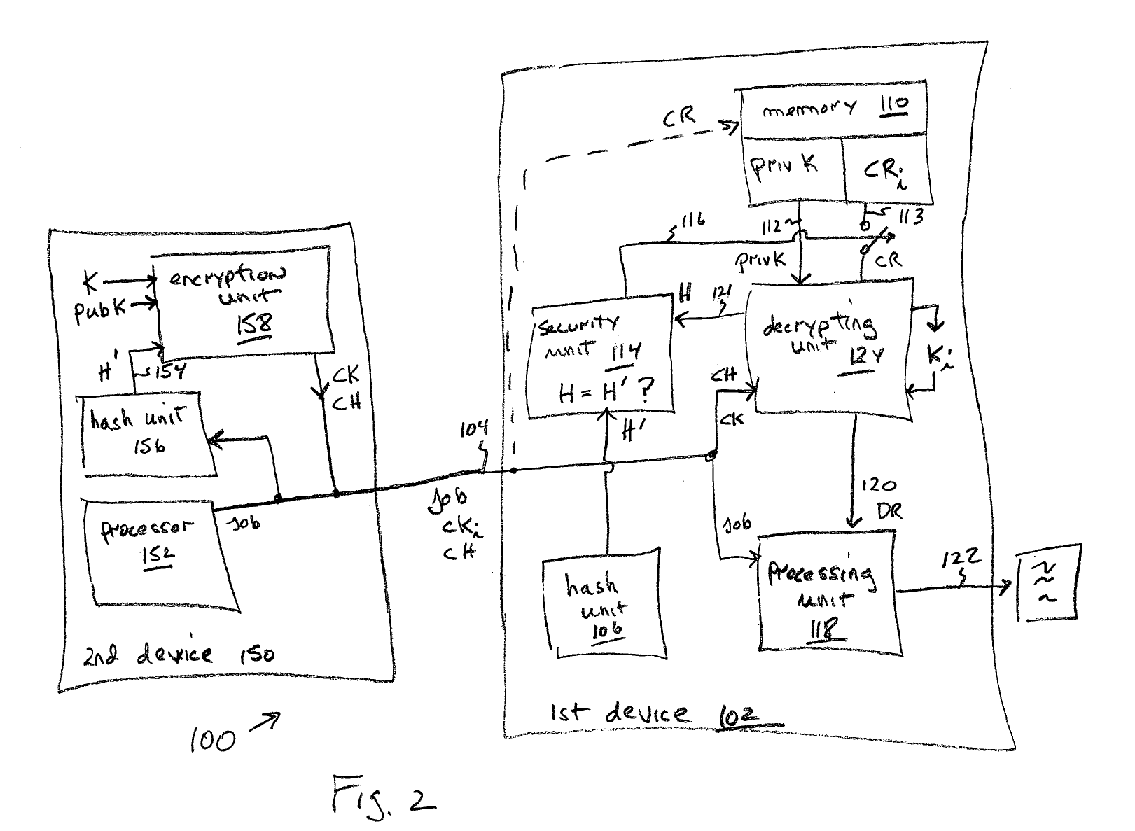

FIG. 2 is a schematic block diagram illustrating an alternate aspect of the system shown in FIG. 1. The system of FIG. 2 is similar to the system of FIG. 1 except as noted below, and the similarities will not be repeated in the interest of brevity. In this aspect, the decrypting unit 124 has an interface on line 104 to accept CH and CK, as well as an interface on line 112 to accept privK from the memory 110. The decryption unit 124 generates K, as in FIG. 1, by using privK to decrypt CK. Then, the decryption unit 124 supplies H on line 121 in response to decrypting CH using K. As above, the decryption unit 124 supplies the decrypted resource (DR) on line 120. The security unit accepts H on line 121 and H′ on line 108, and validates CH by matching H to H′.

Referencing both FIGS. 1 and 2, it should be understood that the system components are typically enabled as software, or microprocessor instruction sets. However, elements of the system may be enabled, or partially enabled, using hardware or firmware components. In one aspect of the system 100, the network-connected port on line 104 receives the encrypted resource for storage in the memory 110. That is, the encrypted resource need not necessarily be installed at the factory or during installation and initialization. The encrypted resource may be received in a hypertext transport protocol (http) or file transport protocol (FTP), for example. However, the invention is not limited to any particular format. To enhance the security of the system, the memory 110 (or a different memory, not shown) may be a read only memory (ROM) for accepting and storing privK upon device initialization.

In one aspect of the system, the first device 102 is a printer. As used herein, printer is understood to be an imaging device that is capable of generating a hardcopy document from an electronic document input. As such, the printer can be an MFP, scanner, or fax device. The invention is not limited to any particular document format. The network-connected port on line 104 may receive a print job in either a text format, such as Word, or an image format, such as a portable document format (PDF) file.

If the first device 102 is a printer, then the encrypted resources in memory 110 may be encrypted font resources, and the processing unit 118 is a print engine that supplies a job on line 122 printed using the decrypted fonts. The encrypted font resources may be a logo, a personal signature image, or a glyph. For example, the personal signature image may be used to “sign” correspondence or checks. However, there are many types of symbols that can be protected for use by selected individuals.

In some aspects, the system 100 further comprises a second device 150, such as a network server or a personal computer. The second device 150 includes a processor 152 to supply the job on line 104. Note, the job may be supplied from memory or created by a document generation application. A hash unit 156 has an interface on line 104 to accept the job and an interface on line 154 to supply a hash of the job (H). An encryption unit 158 has an interface on line 154 to accept H, and an interface of line 104 to supply CK, the encryption of symmetrical encryption key K using pubK, and CH, the encryption of H using K. The second device 150 further includes a network-connected port on line 104 for transmitting the job, CK, and CH to the first device 102 for job processing.

As shown in FIG. 2, the first device network-connected port may receive an encrypted resource selection command on line 104. Then, the decryption unit 124 decrypts the selected resource (CRᵢ). In this manner, numerous resources may be encrypted for use in a common device. For example, different user groups may have differential access to the encrypted resources. More specifically, the decryption unit 124 receives and decrypts CKᵢ, where 1≦i≦m, to recover one of symmetrical encryption keys K₁ through Km, where K₁ through Km correspond to encrypted resources CR₁ through CRₘ. Alternately stated, the particular Kᵢ that is recovered in response to decryption CKᵢ is used to decrypt a corresponding resource CRᵢ. Note, although not shown, this analysis applies to the system of FIG. 1, as well as the system of FIG. 2.

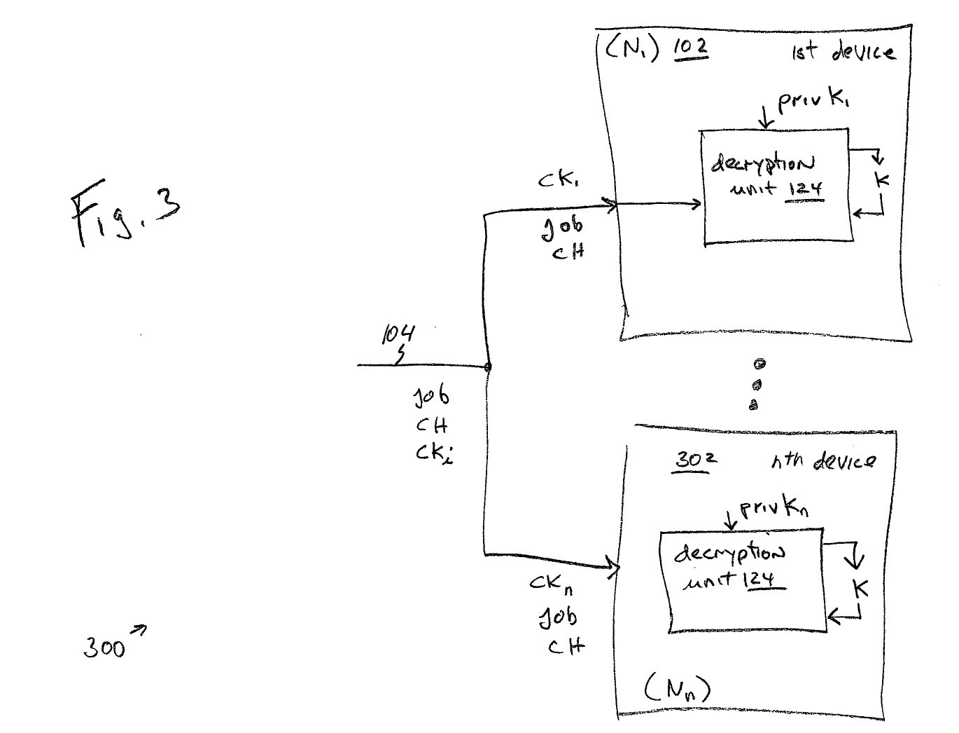

FIG. 3 is a schematic block diagram illustrating a multi-device aspect of the present invention. The system 300 comprises a plurality of devices Nᵢ, where 1≦i≦n. The devices are similar to the first device described in the explanation of FIGS. 1 and 2, and a detailed explanation will not be repeated here in the interest of brevity. Each device uses a different public/private asymmetrical key set. Shown are first device 102 and nth device 302. However, the system 300 is not limited to any particular number. Each device receives the electronically formatted job at a network-connected port on line 104, along with CKᵢ. In this aspect, CKᵢ is generated by encrypting K, using corresponding asymmetrical encryption public key pubKᵢ. Thus, first device 102 (N₁) receives CK₁, the encryption of K using pubK₁. Likewise, nth device 302 (Nₙ) receives CKₙ, the encryption of K using pubKₙ. Each device decryption unit decrypts CKᵢ using corresponding asymmetrical encryption private keys privKᵢ, to recover K. For simplicity, the same job is shown being sent to both devices 102 and 302. Practically however, the jobs are likely to be different, as they may be supplied from different user groups, or sent to different devices for alternate types of processing.

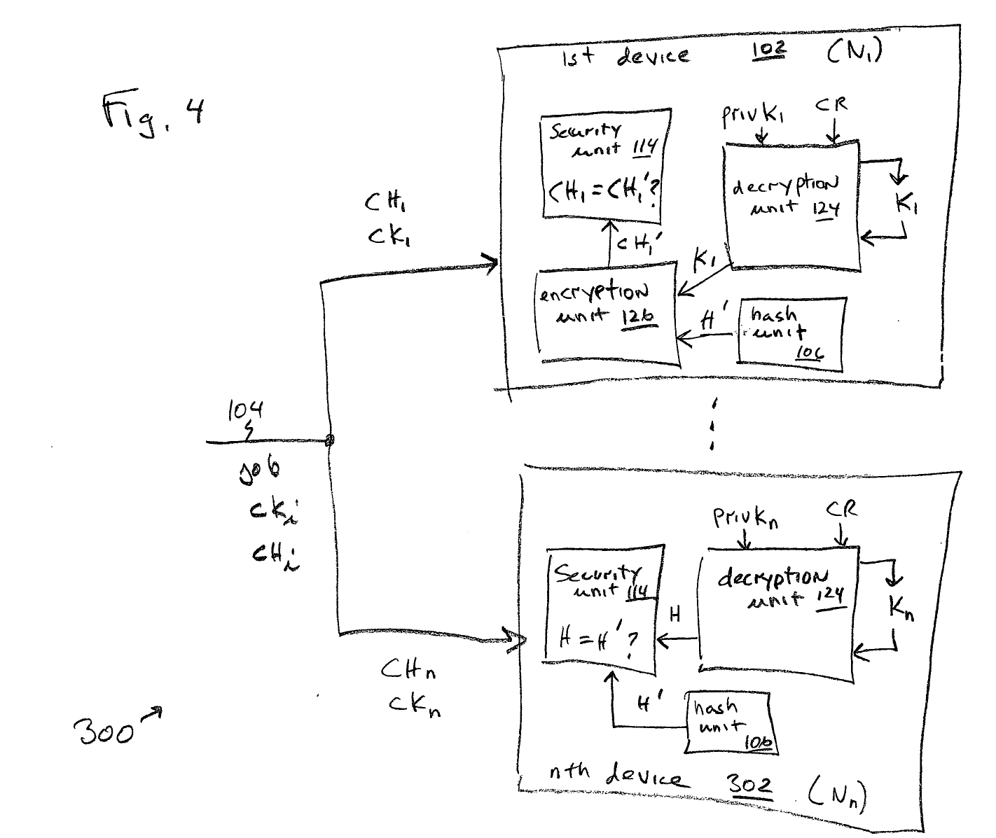

FIG. 4 is a schematic block diagram of the present invention system of FIG. 3, where multiple symmetrical encryption keys are used, in addition to multiple asymmetrical key sets. Again, each device Nᵢ (where 1≦i≦n) receives the electronically formatted job at a network-connected port on line 104, along with CKᵢ. In this aspect, CKᵢ is generated by encrypting Kᵢ using corresponding asymmetrical encryption public key pubKᵢ. For example, the first device 102 (N₁) receives CK₁, the encryption of K₁ using pubK₁. Each device also receives CHᵢ, a hash of the job encrypted using corresponding symmetrical encryption key Kᵢ. For example, the first device 102 (N₁) receives CH₁, a hash of the job that is encrypted using K₁. Likewise, the nth device 302 (Nₙ) receives CKₙ, the encryption of Kₙ using pubKₙ, and CHₙ, a hash of the job that is encrypted using Kₙ.

Each device decryption unit 124 decrypts CKᵢ using asymmetrical encryption private key privKᵢ, to recover corresponding symmetrical encryption key Kᵢ. Then, Kᵢ is used to decrypt of the encrypted resource CR. Thus, the first device 102 (N₁) decrypts CK₁ using privK₁, to recover K₁. K₁ is used to decrypt encrypted resource CR. Note, each device may store the same resource, different resources, or multiple resources. Again, for the sake of simplicity only, each device is shown receiving the same job. Typically, each device receives different jobs.

In one aspect of the invention, using the first device 102 as an example, the encryption unit 126 encrypts H′ using symmetrical encryption key Kᵢ, obtaining CHᵢ′. In this example, H′ is encrypted using K₁, to obtain CH₁′. Then, the device security unit 114 validates CH by matching CHᵢ to corresponding CHᵢ′. In this example, CH₁ is matched to CH₁′. A more detailed explanation of this validation process is provided in the description of FIG. 1.

In another aspect, using nth device 302 as an example, the decryption unit decrypts CHᵢ using symmetrical encryption keys Kᵢ, obtaining H. In this example, H is obtained by decrypting CHₙ using Kₙ. The security unit 114 validates CH by matching H to H′. A more detailed explanation of this validation process is provided in the description of FIG. 2. Note, the system depicted in FIG. 4 is not limited to the use of any particular CH validation method.

### Functional Description

The present invention, enabled as a printer, may enact the following setup process:
1. The printer comes with a public/private encryption key (PrivK, PubK), which is setup at assembly time.
2. The administrator identifies the font as secure.
3. The administrator generates an encryption key K to protect the secure font.
4. The administrator uses K to encrypt the secure font, using a symmetric encryption algorithm. The administrator keeps the key used to encrypt the font (K).
5. The printer administrator uploads encrypted secure fonts to the printer using an upload mechanism provided by the printer manufacturer. This can be either FTP, HTTP, or any other network transport protocol.
6. The printer receives the secure font data and stores the font in its internal storage device. Note, K does not get stored on the printer and, thus, the printer can't decipher the font.
7. The administrator sends out K to all authorized users via a secure channel.

Following installation, the secure resource printer device may be used as follows:
1. Assume that an authorized user wants to send a print job and utilize the secure font.
2. The user encrypts K with the printer's public key (pubK) using an asymmetric algorithm, thus obtaining CK, which constitutes a cipher of K.
3. The user hashes the print job and obtains H, which is a hash of the print job.
4. The user encrypts the hash using a symmetric encryption and K as the key, and obtains CH.
5. The user sends the print job along with CK and CH.
6. The printer receives the print job, and recognizes it as referencing a secure font.
7. The printer attempts to recover K, which is the only way to decrypt and utilize the secure font.
8. The printer uses an asymmetric algorithm to decipher CK and compute K. It is guaranteed that the printer will succeed as it has the private key privK, corresponding to the public key pubK used to encrypt K. In fact, the printer is the only entity that can succeed in this task, as it is the only entity with knowledge of privK.
9. The printer hashes the print job and obtains H′.
10. The printer encrypts H′ with a symmetric encryption algorithm, and K as the key, to obtain CH′.
11. The printer compares CH′ with CH. If there is a match, then the printer can be confident that the user who sent the print job has legitimate access to K1 and, hence, is authorized to use the secure font. If CH′ and CH do not match, the printer rejects the print job.
12. The printer uses K to decrypt the secure font previously uploaded by the administrator.
13. Once the printer computes the secure fonts, they can be utilized for the current print job. The printer uses a secure font to produce a print job.
14. The printer doesn't save a copy of the deciphered secure font, nor does it keep a copy of K, and so looses the ability to use the secure font again, until the next authorized print job arrives. The next authorized print job will reconvey K to the printer.

Note, the above-described utilization process corresponds to the aspect of the invention described by FIG. 1. The process described in FIG. 2 is similar, except for the specific CH validation method.

The following is a description of security provided by the present invention to possible attacks upon the secure resource.

The man in the middle attack:
1. Alice sends a print job to the printer, along with CK and CH.
2. Eve eavesdrops to the communication and intercepts CK and CH.
3. Eve's goal is to obtain K.
4. Eve has CK, which is the encryption of K. However, Eve cannot decipher CK without privK, the only way to decrypt CK.
5. Eve doesn't give up, even though the computation of K has failed. She still hopes to send her own print jobs and use the secure font.
6. Eve knows that CK never changes, and so she can add CK to her print job, which will be used by the printer to obtain K.
7. Eve knows how to compute H, which is the hash of her print job. But alas, what Eve cannot compute is CH, which is the encrypted hash of her document, using K as the key.
8. Thus, Eve cannot prove that she has legitimate access to K, and the printer rejects the print job.
9. The only possible attack that Eve can make is to record the whole session, and then impersonate to an authorized user, by sending the same print job as was previously sent by an authorized user. Then, CH matches the print job, and the print job won't get rejected. This attack is also known as a replay attack. However, this attack yields a very limited benefit to Eve, as she cannot author her own documents. In a sense, it is similar to producing a hard copy of a print job, and then making photocopies with a standard copier.

One strength of this invention is that the administrator can store multiple font sets, each requiring a different key to decrypt it (K₁, K₂, . . . Kₙ). This permits the administrator to set flexible rules as to what subset of users can use which fonts on the printer. In addition, the fonts can be copied to multiple printers. Each printer may have distinct public and private keys (pubK₁,privK₁, pubK₂,PrivK₂, . . . pubKₙ,PrivKₙ) that may be used to enable the invention.

Furthermore, the key for decrypting the font is never stored on the printer itself, so no matter how far an attacker goes, they won't be able to utilize the font. The font cannot be decrypted even if the printer itself is stolen, and its innards hacked in a lab. Key distribution is a non-issue in many cases, as the administrator proliferates K to all authorized users. In a challenging environment, however, secure font keys proliferation is conducted via a public key encryption, in which every user has his own public-private key pair and, thus, the administrator can securely send K to authorized users.

Public encryption is relatively complex, on the order of 1000 to 1 more complex, as compared to symmetric encryption. If a printer had to decrypt print jobs, a bottleneck could easily develop. Therefore, instead of encrypting the print job, it is much cheaper (less computationally complex) to produce a hash of the print job, and encrypt the hash.

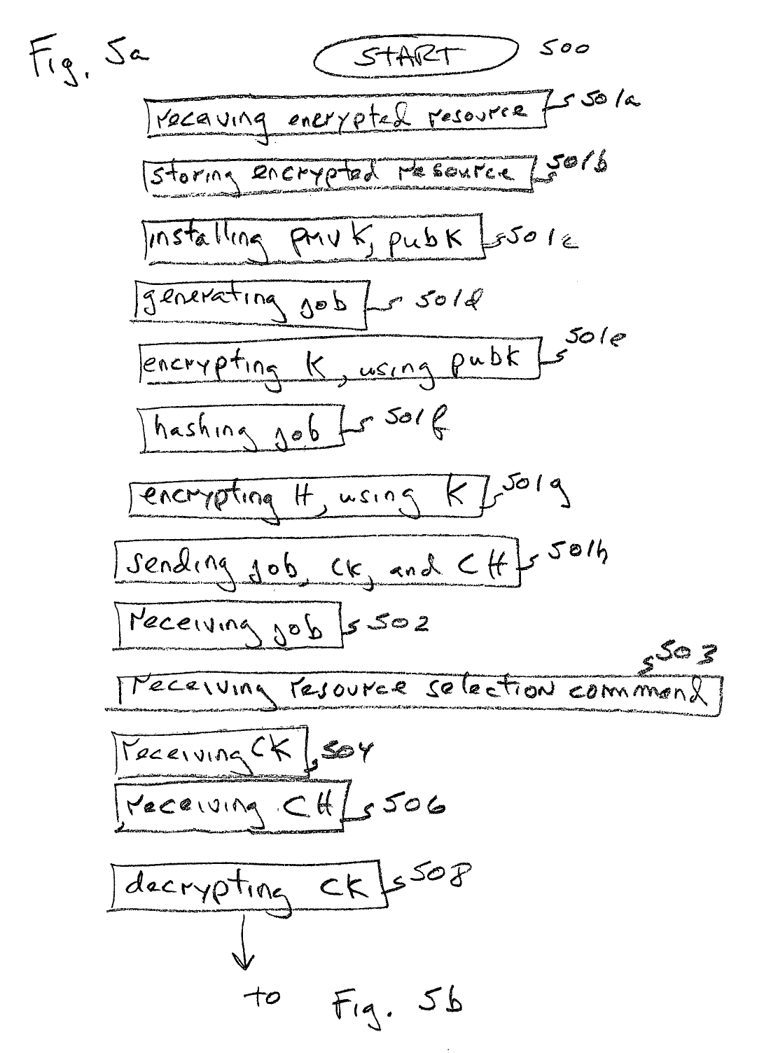

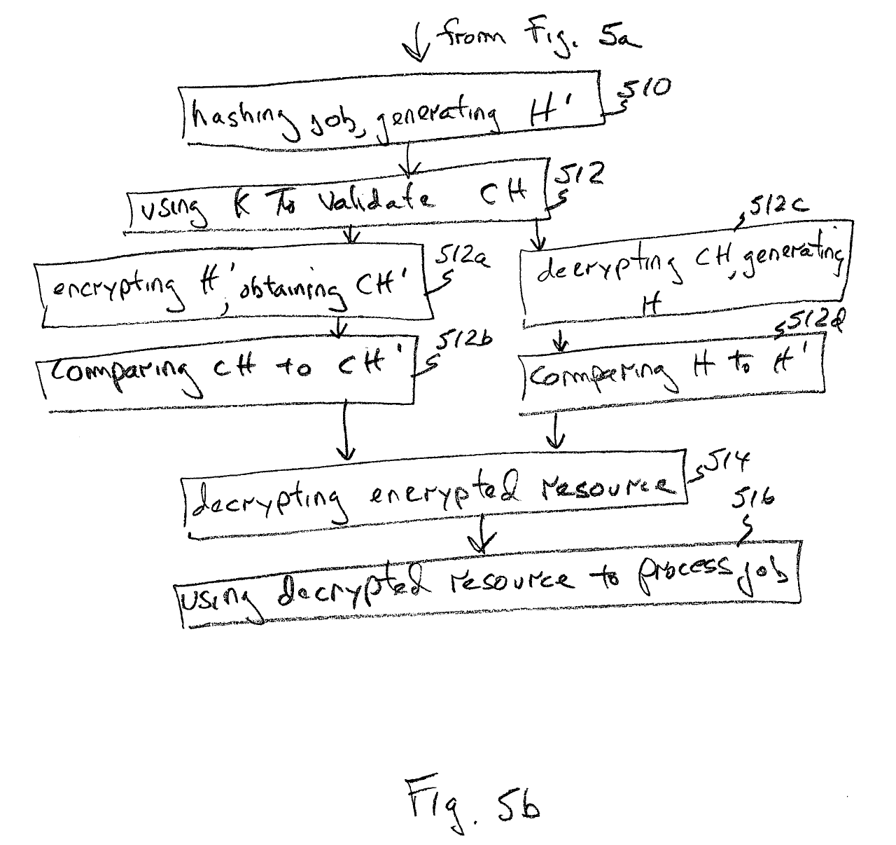

FIGS. 5a and 5b are flowcharts illustrating the present invention method for securing network-connected resources. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 500.

Step 502 receives an electronically formatted job at a first network-connected node. Step 502 can receive a print job in either a text or image format. Note that is some aspects of the invention, the input can be a paper medium, such as blank checks requiring a (secure font) signature. However, this aspect still requires the use of an electronically formatted CK and CH, see Step 504 and 506. Step 504 receives CK, a symmetrical encryption key (K) encrypted using an asymmetrical encryption public key (pubK). Step 506 receives CH, a hash (H) of the job, further encrypted using K. Step 508 decrypts CK using an asymmetrical encryption private key (privK), corresponding to pubK, to recover K. Step 510 hashes the job, generating H′. Step 512 uses K to validate CH. Step 514 decrypts an encrypted resource using K in response to validating CH. Step 516 uses the decrypted resource to process the job.

In one aspect of the method, using K to validate CH in Step 512 includes substeps. Step 512a encrypts H′ using K, obtaining CH′. Step 512b matches CH to CH′. Another aspect uses alternate substeps. Step 512c decrypts CH using K, generating H. Step 512d compares H to H′.

In one aspect, prior to receiving the job (Step 502), CK (Step 504), and CH (Step 506), Step 501a receives the encrypted resource. Step 501a may receive the encrypted resource in a format such as http or FTP. Step 501b stores the encrypted resource. For example, Step 501b may store an encrypted font resource. Then, using the decrypted resource to process the job in Step 516 includes printing a print job using the decrypted fonts. Step 501b may store resources such as a logo, personal signature image, or glyph. In another aspect, Step 501c installs pubK,privK upon initialization.

In one aspect, Step 501d generates the job at a second network-connected node. Step 501e encrypts K with pubK, generating CK. Step 501f hashes the job, generating H. Step 501g encrypts H using K, generating CH. Step 501h sends the job, CK, and CH to the first node for job processing.

In one aspect of the method, a further step, Step 503, receives a selection command for a particular one of a plurality of encrypted resources. Then, decrypting an encrypted resource using K (Step 514) includes decrypting the selected resource. In another aspect, Step 503 receives a selection command for a particular one of a plurality of encrypted resources by receiving CKᵢ, where 1≦i≦m. In this aspect, Steps 503 and 504 are the same step. Then, decrypting the selected resource in response to the encrypted resource selection command (Step 514) includes decrypting CKᵢ to recover one of symmetrical encryption keys K₁ through Km, where K₁ through Km correspond to encrypted resources CR₁ through CRₘ.

In another aspect, Step 502 receives the job at network-connected node Nᵢ, where 1≦i≦n. Step 504 includes Nᵢ receiving CKᵢ, where CKᵢ is generated by encrypting K using corresponding asymmetrical encryption public key pubKᵢ. Step 508 includes Nᵢ decrypting CKᵢ using corresponding asymmetrical encryption private key privKᵢ, to recover K.

In a different aspect, Step 502 receives the job at network-connected node Nᵢ, where 1≦i≦n, and Step 504 includes Nᵢ receiving CKᵢ, corresponding to symmetrical encryption key Kᵢ, encrypted using pubKᵢ. Likewise, Step 506 includes Nᵢ receiving CHᵢ, a hash of the job encrypted using corresponding symmetrical encryption key Kᵢ. Then, Step 508 includes Nᵢ decrypting CKᵢ using asymmetrical encryption private key privKᵢ, to recover corresponding symmetrical encryption key Kᵢ.

In Step 512a Nᵢ encrypts H′ using symmetrical encryption key Kᵢ, obtaining CHᵢ′, and in Step 512b Nᵢ matches CHᵢ to corresponding CHᵢ′. Alternately, in Step 512c Nᵢ decrypts CHᵢ using symmetrical encryption key Kᵢ, obtaining H, and in Step 512d Nᵢ compares H to H′. Either way, in Step 514 Nᵢ decrypts the encrypted resource using symmetrical encryption key Kᵢ.

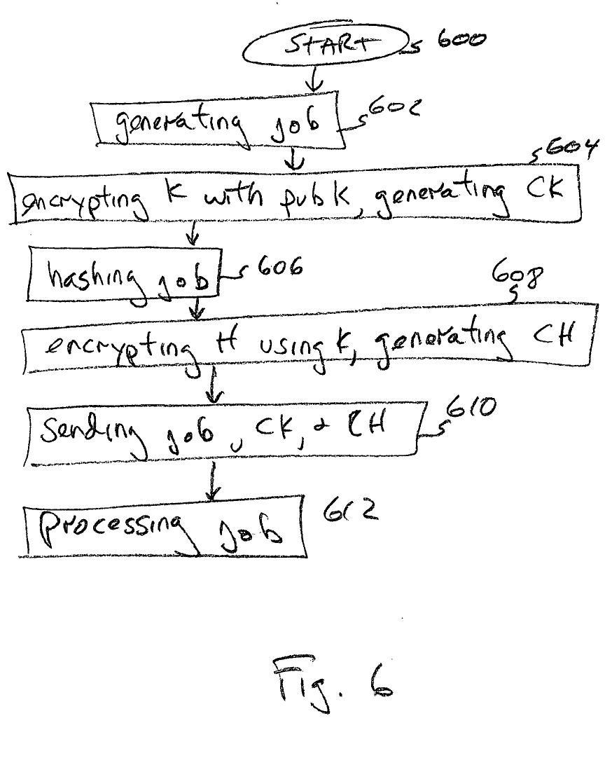

FIG. 6 is a flowchart illustrating the present invention method for accessing network-connected processing resources. The method starts at Step 600. Step 602 generates an electronically formatted job at a second node. Step 604 encrypts a symmetrical encryption key K with an asymmetrical encryption key (pubK), generating CK. Step 606 hashes the job generating H. Step 608 encrypts H using K, generating CH. Step 610 sends the job, CK, and CH to a first network-connected node. Step 612 processes the job at the first node using a K encrypted resource.

A system and method for using encrypted network resources has been provided. The invention has been explained in the context of a printer loaded with encrypted fonts. However, the invention has broader application, to the secure use of any kind of network-accessible resource. Other variations and embodiments of the invention will occur to those skilled in the art.

1. A method for securing network-connected resources, the method comprising:
at a first network-connected node, receiving an electronically formatted job;
receiving CK, a symmetrical encryption key (K) encrypted using an asymmetrical encryption public key (pubK);
receiving CH, a hash (H) of the job, further encrypted using K;
decrypting CK using an asymmetrical encryption private key (privK), corresponding to pubK, to recover k;
hashing the job, generating H′;
using K to validate CH;
in response to validating CH, decrypting an encrypted resource using K; and,
using the decrypted resource to process the job.

2. The method of claim 1 wherein using K to validate CH includes:
encrypting H′ using K, obtaining CH′; and,
matching CH to CH′.

3. The method of claim 1 wherein using K to validate CH includes:
decrypting CH using K, generating H; and,
comparing H to H′.

4. The method of claim 1 further comprising:
prior to receiving the job, CK, and CH, receiving the encrypted resource; and,
storing the encrypted resource.

5. The method of claim 4 further comprising:
installing pubK,privK upon initialization.

6. The method of claim 1 wherein receiving an electronically formatted job includes receiving a print job in a format selected from the group including text and image formats.

7. The method of claim 4 wherein storing the encrypted resource includes storing an encrypted font resource; and,
wherein using the decrypted resource to process the job includes printing a print job using the decrypted fonts.

8. The method of claim 7 wherein storing the encrypted font resource includes storing resources selected from the group including a logo, personal signature image, and glyph.

9. The method of claim 4 wherein receiving the encrypted resource includes receiving the encrypted resource in a format selected from the group including hypertext transport protocol (http) and file transport protocol (FTP).

10. The method of claim 1 further comprising:
at a second network-connected node, generating the job;
encrypting K with pubK, generating CK;
hashing the job, generating H;
encrypting H using K, generating CH; and,
sending the job, CK, and CH to the first node for job processing.

11. The method of claim 1 further comprising:
receiving a selection command for a particular one of a plurality of encrypted resources; and,
wherein decrypting an encrypted resource using K, in response to a valid match, includes decrypting the selected resource.

12. The method of claim 11 wherein receiving a selection command for a particular one of a plurality of encrypted resources includes receiving CKᵢ, where 1≦i≦m; and,
wherein decrypting the selected resource in response to the encrypted resource selection command includes decrypting CKᵢ to recover one of symmetrical encryption keys K₁ through Km, where K₁ through Km correspond to encrypted resources CR₁ through CRₘ.

13. The method of claim 1 wherein receiving an electronically formatted job includes receiving the job at network-connected node Nᵢ, where 1≦i≦n;
wherein receiving CK includes Nᵢ receiving CKᵢ, where CKᵢ is generated by encrypting K using corresponding asymmetrical encryption public key pubKᵢ; and,
wherein decrypting CK includes Nᵢ decrypting CKᵢ using corresponding asymmetrical encryption private key privKᵢ, to recover K.

14. The method of claim 1 wherein receiving an electronically formatted job includes receiving the job at network-connected node Nᵢ, where 1≦i≦n;
wherein receiving CK includes Nᵢ receiving CKᵢ, corresponding to symmetrical encryption key Kᵢ, encrypted using pubKᵢ;
wherein receiving CH includes Nᵢ receiving CHᵢ, a hash of the job encrypted using corresponding symmetrical encryption key Kᵢ; and,
wherein decrypting CK includes Nᵢ decrypting CKᵢ using asymmetrical encryption private key privKᵢ, to recover corresponding symmetrical encryption key Kᵢ.

15. The method of claim 14 wherein using K to validate CH includes:
Nᵢ encrypting H′ using symmetrical encryption key Kᵢ, obtaining CHᵢ′;
Nᵢ matching CHᵢ to corresponding CHᵢ′; and,
wherein decrypting an encrypted resource using K includes Nᵢ decrypting the encrypted resource using symmetrical encryption key Kᵢ.

16. The method of claim 14 wherein using K to validate CH includes:
Nᵢ decrypting CHᵢ using symmetrical encryption key Kᵢ, obtaining H;
Nᵢ comparing H to H′; and,
wherein decrypting an encrypted resource using K includes Nᵢ decrypting the encrypted resource using symmetrical encryption key Kᵢ.

17. A method for accessing network-connected processing resources, the method comprising:
at a second node, generating an electronically formatted job;
encrypting a symmetrical encryption key K with an asymmetrical encryption key (pubK), generating CK;
hashing the job generating H;
encrypting H using K, generating CH;
sending the job, CK, and CH to a first network-connected node; and,
processing the job at the first node using a K encrypted resource.

18. A system for using secure network-connected resources, the system comprising:
a first device including:
a network-connected port for receiving an electronically formatted job, for receiving CK, a symmetrical encryption key (K) encrypted using an asymmetrical encryption public key (pubK), and for receiving CH, a hash (H) of the job, further encrypted using K;
a hash unit having an interface to accept the job and to supply a hash of the job (H′);
a memory having an interface to supply an asymmetrical encryption private key (privK), corresponding to pubK, and an encrypted resource;
a security unit having an interface to authorize access to the encrypted resource in memory, in response to validating CH; and,
a processing unit having an interface to accept the job and a decrypted resource, and to supply a job processed using the decrypted resource.

19. The system of claim 18 further comprising:
a decrypting unit having an interface to accept CK and privK, to generate K in response to decrypting CK using privK, to decrypt the encrypted resource from memory using K, and supply the decrypted resource;
an encryption unit having an interface to accept H′ and K, and supply CH′ in response to using K to encrypt H′; and,
wherein the security unit accepts CH and CH′ and validates CH by matching CH to CH′.

20. The system of claim 18 further comprising:
a decrypting unit having an interface to accept CH, CK, and privK, to generate K in response to decrypting CK using privK, to supply H in response to decrypting CH using K, and supply the decrypted resource; and,
wherein the security unit accepts H and H′ and validates CH by matching H to H′.

21. The system of claim 18 wherein the network-connected port receives the encrypted resource for storage in the memory.

22. The system of claim 18 wherein the memory is a read only memory (ROM) for accepting and storing privK upon device initialization.

23. The system of claim 18 wherein the first device is a printer; and,
wherein the network-connected port receives a print job in a format selected from the group including text and image formats.

24. The system of claim 23 wherein the memory stores encrypted font resources; and,
wherein the processing unit is a print engine that supplies a job printed using the decrypted fonts.

25. The system of claim 24 wherein the memory stores encrypted font resources selected from the group including a logo, personal signature image, and glyph.

26. The system of claim 21 wherein the network-connected port receives an encrypted resource for storage in a format selected from the group including hypertext transport protocol (http) and file transport protocol (FTP).

27. The system of claim 18 further comprising:
a second device including:
a processor to supply a job;
a hash unit having an interface to accept the job and to supply a hash of the job (H);
an encryption unit having an interface to accept H, to supply CK, the encryption of symmetrical encryption key K using pubK, and CH, the encryption of H using K; and,
a network-connected port for transmitting the job, CK, and CH to the first device for job processing.

28. The system of claim 18 wherein the first device network-connected port receives a encrypted resource selection command; and,
wherein the decryption unit decrypts the selected resource.

29. The system of claim 28 wherein the decryption unit decrypts CKᵢ, where 1≦i≦m, to recover one of symmetrical encryption keys K₁ through Km, where K₁ through Km correspond to encrypted resources CR₁ through CRₘ.

30. The system of claim 18 further comprising:
a plurality of devices Nᵢ, where 1≦i≦n, each receiving the electronically formatted job at a network-connected port, along with CKᵢ, where CKᵢ is generated by encrypting K using corresponding asymmetrical encryption public key pubKᵢ; and,
wherein each device decryption unit decrypts CKᵢ using corresponding asymmetrical encryption private key privKᵢ, to recover K.

31. The method of claim 18 further comprising:
a plurality of devices Nᵢ, where 1≦i≦n, each receiving the electronically formatted job at a network-connected port, along with CKᵢ, where CKᵢ is generated by encrypting Kᵢ using corresponding asymmetrical encryption public key pubKᵢ, and CHᵢ, a hash of the job encrypted using corresponding symmetrical encryption key Kᵢ; and,
wherein each device includes a decryption unit for decrypting CKᵢ using asymmetrical encryption private key privKᵢ, to recover corresponding symmetrical encryption key Kᵢ, for the decryption of the encrypted resource.

32. The system of claim 31 wherein each device encryption unit encrypts H′ using symmetrical encryption key Kᵢ, obtaining CHᵢ′; and,
wherein each device security unit validates CH by matching CHᵢ to corresponding CHᵢ′.

33. The system of claim 31 wherein each device decryption unit decrypts CHᵢ using symmetrical encryption key Kᵢ, obtaining H; and,
wherein each device security unit validates CH by matching H to H′.

34. A system for accessing network-connected processing resources, the system comprising:
a second device including:
a processor to supply a job;
a hash unit having an interface to accept the job and to supply a hash of the job (H);
an encryption unit having an interface to accept H, to supply CK, the encryption of symmetrical encryption key K using pubK, and CH, the encryption of H using K; and,
a network-connected port for transmitting the job, CK, and CH to a first device for job processing.
